(19) United States
(12) Patent Application Publication
(10) Pub. No.: US 2020/0056960 A1
(43) Pub. Date: Feb. 20, 2020

(54) FUSION SPLICING SYSTEM, FUSION SPLICER AND METHOD OF DETERMINING TYPE OF OPTICAL FIBER

(71) Applicant: FURUKAWA ELECTRIC CO., LTD., Tokyo (JP)

(72) Inventors: Tomofumi KISE, Tokyo (JP); Jun NISHINA, Tokyo (JP); Keiji MASHIMO, Tokyo (JP); Hideaki HOSOI, Tokyo (JP); Masaki HATTORI, Tokyo (JP)

(73) Assignee: FURUKAWA ELECTRIC CO., LTD., Tokyo (JP)

(21) Appl. No.: 16/529,016

(22) Filed: Aug. 1, 2019

(30) Foreign Application Priority Data
Aug. 2, 2018 (JP) 2018-146080

(51) Int. Cl. G01M 11/00; G06K 9/00; G06K 9/62; G06T 5/00

(52) U.S. Cl. CPC G01M 11/35; G06K 9/00671; G06K 9/6256; G06T 5/009; G06K 2209/19; G06T 2207/20081; G06T 2207/30108; G06K 2209/21; G06T 2207/20084

(57) ABSTRACT

Brightness profile data are extracted based on side view image data of an optical fiber, machine learning is performed by using teacher data indicating a correspondence relationship between brightness profile in a radial direction of the optical fiber and a type of the optical fiber, the teacher data being created based on the brightness profile data, a classification model is created to be able to determine the type of the optical fiber for an arbitrary optical fiber based on the brightness profile data indicating brightness profile in the radial direction of the arbitrary optical fiber, and the type of the optical fiber is determined for each of a pair of optical fibers by using the classification model based on the brightness profile data that is extracted based on side view image data of the pair of optical fibers as a target. The pair of optical fibers are fusion-spliced based on a fusion condition that is set in accordance with a combination of respective determined types of the optical fibers.

### CROSS-REFERENCE TO RELATED APPLICATIONS

The present application claims priority to and incorporates by reference the entire contents of Japanese Patent Application No. 2018-146080 filed in Japan on Aug. 2, 2018.

### BACKGROUND OF THE INVENTION

### 1. Field of the Invention

The present invention relates to a fusion splicing system, a fusion splicer, and a method of determining a type of an optical fiber.

### 2. Description of the Related Art

In the related art, there is known a fusion splicer used for fusion splicing of optical fibers (for example, refer to Japanese Laid-open Patent Publication No. 2010-128290 and Japanese Laid-open Patent Publication No. 2002-169050). Typically, a fusion splicer successively performs a position recognition step of recognizing positions of end parts of a pair of optical fibers as a target of fusion splicing, and an axis alignment step of aligning center axes (core axes) of the pair of optical fibers the positions of which are recognized. Subsequently, the fusion splicer successively performs a heating step of heating and melting the end parts of the pair of optical fibers the axes of which are aligned, and a splicing step of butting the respective end parts of the pair of optical fibers that are heated and melted against each other to be spliced. Thereafter, the fusion splicer successively performs an inspection step of optically inspecting a fusion-spliced portion of the pair of optical fibers through image processing and the like, and a reinforcing step of mechanically reinforcing the fusion-spliced portion with a reinforcing member such as a sleeve. Through a series of steps from the position recognition step to the reinforcing step described above, the fusion splicer completes fusion splicing of the pair of optical fibers.

At each step of the series of steps performed by the fusion splicer to fusion-splice the pair of optical fibers as described above, control is performed by a control unit of the fusion splicer. That is, at each step of the series of steps performed by the fusion splicer, the control unit controls a functional unit of the fusion splicer based on various set values of a fusion condition required for fusion-splicing the pair of optical fibers as a target of fusion splicing. The various set values of the fusion condition include a set value that should be changed depending on a type of an optical fiber of each of the pair of optical fibers to be fusion-spliced (specifically, material, a structure, dimensions, and the like of the optical fiber that are different depending on the type of the optical fiber), a wavelength of light to be transmitted through the pair of optical fibers after fusion splicing (hereinafter, referred to as a “transmission light wavelength”) and the like. Hereinafter, each of the set values included in the fusion condition is referred to as a “parameter”, and a group of parameters constituting the fusion condition is referred to as a “parameter set”.

A storage unit of the fusion splicer stores a large number of parameter sets that are known at the time when the fusion splicer is manufactured or sold. The fusion splicer selects a parameter set required for fusion splicing of the pair of optical fibers from among the large number of parameter sets in the storage unit in accordance with the type, the transmission light wavelength and the like of the pair of optical fibers as a target of fusion splicing, and switches the fusion condition to the selected parameter set. By successively performing the series of steps described above based on the fusion condition (parameter set) that has been switched as described above, the fusion splicer can fusion-splices the pair of optical fibers with high finished quality (for example, with a low splicing loss).

### SUMMARY OF THE INVENTION

An object of the present invention is to solve at least part of the problem of the known technique described above.

A fusion splicing system according to an embodiment of the present invention includes: a brightness profilebrightness profile extracting unit extracting brightness profilebrightness profile data indicating brightness profilebrightness profile in a radial direction of an optical fiber based on side view image data imaged from the radial direction of the optical fiber; a determination model creation unit performing machine learning by using teacher data, which are created based on the brightness profilebrightness profile data and indicate a correspondence relationship between the brightness profilebrightness profile in the radial direction of the optical fiber and a type of the optical fiber, and creating a determination model that is able to determine the type of the optical fiber for an arbitrary optical fiber based on the brightness profilebrightness profile data indicating the brightness profile in the radial direction of the arbitrary optical fiber; a determination unit determining the type of the optical fiber of each of a pair of optical fibers using the classification model based on the brightness profile data that is extracted by the brightness profile extracting unit based on the side view image data of the pair of optical fibers as a target of fusion splicing; and a functional unit fusion-splicing the pair of optical fibers based on a fusion condition that is set in accordance with a combination of determined types of the optical fibers.

A fusion splicer according to an embodiment of the present invention includes: a brightness profile extracting unit extracting brightness profile data indicating brightness profile in a radial direction of a pair of optical fibers based on side view image data imaged from the radial direction of the pair of optical fibers as a target of fusion splicing; a determination unit determining a type of the optical fiber for each of the pair of optical fibers by using a classification model based on the brightness profile data of the pair of optical fibers extracted by the brightness profile extracting unit; and a functional unit fusion-splicing the pair of optical fibers based on a fusion condition that is set in accordance with a combination of determined types of the optical fibers. Further, the classification model is created to perform machine learning by using teacher data indicating a correspondence relationship between the brightness profile in the radial direction of the optical fiber and the type of the optical fiber, and to be able to determine a type of the optical fiber for an arbitrary optical fiber based on brightness profile data indicating brightness profile in a radial direction of the arbitrary optical fiber, and the teacher data are created to indicate a correspondence relationship between the brightness profile in the radial direction of the optical fiber and the type of the optical fiber based on the brightness profile data extracted from the side view image data of the optical fiber.

A method of determining a type of an optical fiber according to an embodiment of the present invention, the method includes: extracting brightness profile data indicating brightness profile in a radial direction of an optical fiber based on side view image data imaged from the radial direction of the optical fiber; performing machine learning by using teacher data, which are created based on the brightness profile data and indicate a correspondence relationship between the brightness profile in the radial direction of the optical fiber and a type of the optical fiber and creating a classification model that is able to determine the type of the optical fiber for an arbitrary optical fiber based on brightness profile data indicating brightness profile in the radial direction of the arbitrary optical fiber; and determining the type of the optical fiber for each of a pair of optical fibers using the classification model based on brightness profile data that is extracted based on side view image data of the pair of optical fibers as a target.

It is possible to further understand the above description, other objects, characteristics, advantages, and technical and industrial values of the present invention by reading the following detailed description of the present invention with reference to the attached drawings.

### BRIEF DESCRIPTION OF THE DRAWINGS

FIG. 1 is a diagram illustrating a configuration example of a fusion splicing system according to an embodiment of the present invention;

FIG. 2 is a diagram illustrating a configuration example of a fusion splicer according to the embodiment of the present invention;

FIG. 3 is a diagram illustrating an example of respective parameters of a fusion condition used for a functional unit of the fusion splicer according to the embodiment of the present invention;

FIG. 4 is a flowchart illustrating an example of a processing procedure at the time of creating a classification model of a type of an optical fiber to be deployed in the fusion splicer according to the embodiment of the present invention;

FIG. 5 is a diagram illustrating imaging of side view image data of the optical fiber according to the embodiment of the present invention;

FIG. 6 is a diagram illustrating extraction of brightness profile data of the optical fiber according to the embodiment of the present invention;

FIG. 7 is a diagram illustrating an example of teacher data used for machine learning according to the embodiment of the present invention;

FIG. 8 is a flowchart illustrating an example of a processing procedure at the time of fusion-splicing the pair of optical fibers as a target of fusion splicing according to the embodiment of the present invention;

FIG. 9 is a flowchart illustrating an example of a processing procedure at the time of updating the classification model of the type of the optical fiber to be deployed in the fusion splicer according to the embodiment of the present invention; and

FIG. 10 is a diagram exemplifying luminance image data as brightness profile data indicating brightness profile in a radial direction of the optical fiber according to the present invention.

### DETAILED DESCRIPTION OF THE PREFERRED EMBODIMENTS

The following describes an embodiment of a fusion splicing system, a fusion splicer, and a method of determining a type of an optical fiber according to the present invention in detail based on the attached drawings. The present invention is not limited to the embodiment, and can be variously modified without departing from the gist of the present invention. In the respective drawings, the same elements or corresponding elements are appropriately denoted by the same reference numeral. Additionally, it should be noted that the drawings are merely schematic, and a relationship between dimensions of the respective elements, a ratio of each element, and the like may be different from those of actual elements. The drawings may include portions in which relations between dimensions or ratios are different from each other.

In a field of optical fibers, for example, various optical fibers are on the market such as a single-mode optical fiber, a multi-mode optical fiber, a polarization maintaining optical fiber, and an optical fiber for transmitting laser light that are classified according to use or an optical characteristic, and optical fibers that are classified according to a physical characteristic such as a diameter, a core diameter, material of a core portion and a cladding portion, a refractive index profile in a radial direction and the like of an optical fiber. Every year, a large number of new types of optical fibers are put on the market by manufacturers of optical fibers. Thus, the number of combinations of all types of optical fibers (types of optical fibers) on the market, for example, the number of combinations of respective types of optical fibers of a pair of optical fibers as a target of fusion splicing is enormous, and tends to be increased year by year.

On the other hand, a large number of parameter sets that are known at the time of manufacture or sale thereof are set in advance (preset) in the fusion splicer. In a case of fusion-splicing a pair of optical fibers using such a fusion splicer in the related art, it is required that an operator determines the type of the optical fiber for each of the pair of optical fibers as a target, and the operator selects a parameter set adapted to the fusion splicing from among the large number of preset parameter sets. However, the number of combinations of types of optical fibers is enormous as described above, so that there is the problem that it takes much time and labor to determine the type of the optical fiber for each pair of optical fibers as a target by a user.

Whereas, according to the embodiment of a fusion splicing system, a fusion splicer, and a method of determining a type of an optical fiber described below, it is possible to easily shorten the time taken for determining the type of the optical fiber for each pair of optical fibers as a target.

Configurations of Fusion Splicing System and Fusion Splicer

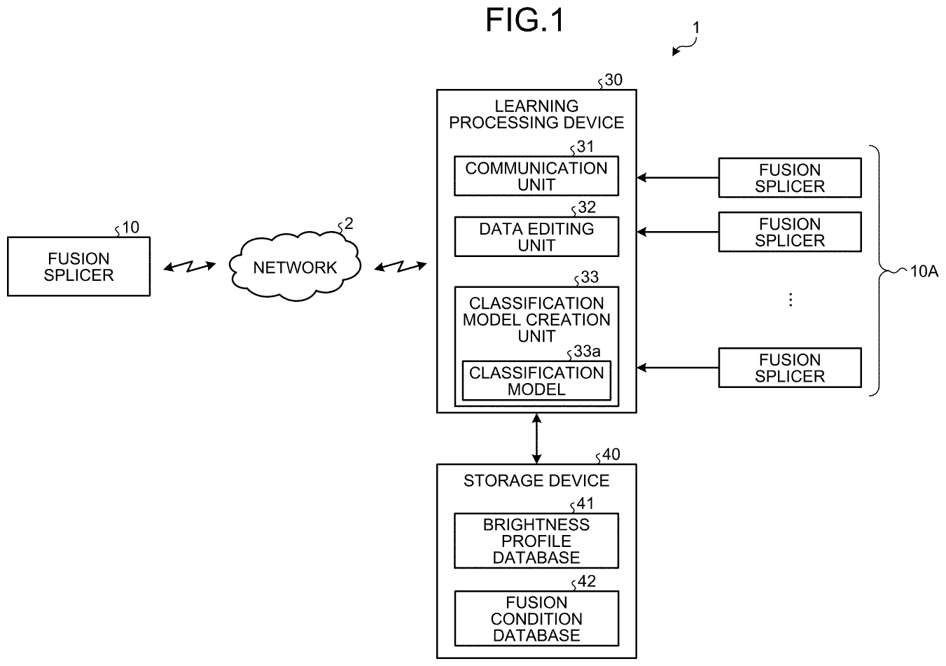

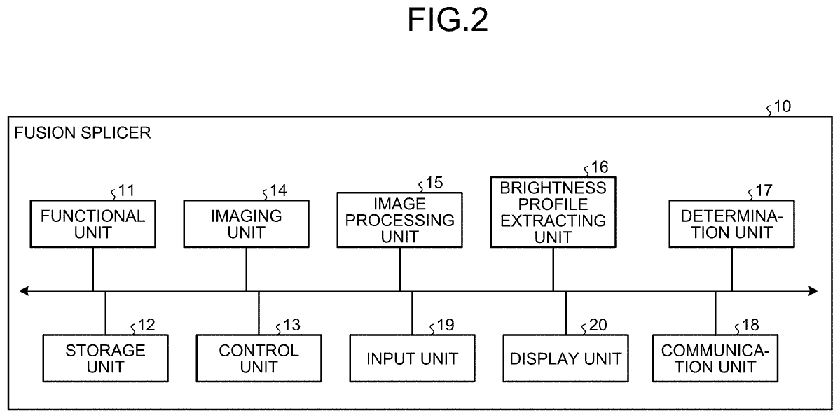

First, the following describes configurations of the fusion splicing system and the fusion splicer according to the embodiment of the present invention. FIG. 1 is a diagram illustrating a configuration example of the fusion splicing system according to the embodiment of the present invention. FIG. 2 is a diagram illustrating a configuration example of the fusion splicer according to the embodiment of the present invention. As illustrated in FIG. 1, a fusion splicing system 1 according to the present embodiment includes at least one fusion splicer (a fusion splicer 10 and a group of fusion splicers 10A in the present embodiment), a learning processing device 30 configured to be able to communicate with the fusion splicer 10 and each fusion splicer of the group of fusion splicers 10A via a network 2 and the like, and a storage device 40 that stores various kinds of data coped with by the learning processing device 30.

The fusion splicer 10 is, for example, an example of a fusion splicer used for fusion splicing of optical fibers by the user. The group of fusion splicers 10A are, for example, an example of a plurality of fusion splicers used for collecting, by a manufacturer side, data required for learning processing for creating a classification model 33a that contributes to determination of the type of the optical fiber. The fusion splicers included in the group of fusion splicers 10A have individual differences between devices (for example, an individual difference in an optical system and the like), but the fusion splicers have the same configuration as that of the fusion splicer 10 on the user side. The following describes the configuration of the fusion splicer 10 as a representative of the fusion splicer 10 and the group of fusion splicers 10A.

As illustrated in FIG. 2, the fusion splicer 10 includes a functional unit 11 for performing fusion splicing of optical fibers, a storage unit 12 in which a plurality of parameter sets are preset, and a control unit 13 that controls each constituent part of the fusion splicer 10. The fusion splicer 10 also includes an imaging unit 14 that images image data viewed from a radial direction of the optical fiber (hereinafter, referred to as side view image data), an image processing unit 15 that performs various kinds of processing on the side view image data of the optical fiber, a brightness profile extracting unit 16 that extracts brightness profile data of the optical fiber, and a determination unit 17 that determines the type of the optical fiber. The fusion splicer 10 further includes a communication unit 18 for performing data communication with the outside, an input unit 19 for inputting various kinds of information, and a display unit 20 that displays various kinds of information.

The functional unit 11 fusion-splices a pair of optical fibers (specifically, respective end parts of the pair of optical fibers) as a target of fusion splicing based on a fusion condition. The fusion condition is set in accordance with a combination of types of optical fibers (in the present embodiment, respective types of optical fibers of the pair of optical fibers as a target of fusion splicing) determined by the determination unit 17 (described later). Although not specifically illustrated, the functional unit 11 is constituted of, for example, a microscope unit for fusion-splicing the optical fibers, an axis aligning mechanism, a heating device, a feeding mechanism, a reinforcing mechanism and the like.

In the present embodiment, the functional unit 11 successively performs a position recognition step of recognizing positions of the respective end parts of the pair of optical fibers as a target of fusion splicing through image processing performed by the microscope unit, and an axis alignment step of aligning center axes (core axes) and rotational positions around the center axes of the pair of optical fibers the positions of which are recognized using the axis aligning mechanism. Subsequently, the functional unit 11 successively performs a heating step of heating and melting the respective end parts of the pair of optical fibers the axes of which are aligned using the heating device, and a splicing step of butting the respective end parts of the pair of optical fibers that are heated and melted against each other using the feeding mechanism to fusion-splice the pair of optical fibers. Thereafter, the functional unit 11 performs an inspection step of optically inspecting a fusion-spliced portion of the pair of optical fibers through image processing performed by the microscope unit. The functional unit 11 also performs a reinforcing step of mechanically reinforcing the fusion-spliced portion of the pair of optical fibers after the inspection step with a reinforcing member such as a sleeve using the reinforcing mechanism. Through a series of steps from the position recognition step to the reinforcing step described above, the functional unit 11 completes fusion splicing of the pair of optical fibers corresponding to a desired transmission light wavelength.

In the present embodiment, the type of the optical fiber is a type of an optical fiber that is classified according to a structure parameter and a manufacturer of the optical fiber. That is, the type of the optical fiber is assumed to be the same type for optical fibers the structure parameter and the manufacturer of which are both the same, and is assumed to be a different type for each of optical fibers at least one of the structure parameter and the manufacturer of which is different. For example, in a case in which the structure parameter and the manufacturer of a first optical fiber are the same as those of a second optical fiber, the types of the optical fibers of the first optical fiber and the second optical fiber are the same type. On the other hand, in a case in which the structure parameter or the manufacturer of the first optical fiber is different from that of the second optical fiber, the types of the optical fibers of the first optical fiber and the second optical fiber are different types. Even when the structure parameter of the first optical fiber is the same as that of the second optical fiber, the types of the optical fibers of the first optical fiber and the second optical fiber are different types if the manufacturer of the first optical fiber is different from that of the second optical fiber. As the structure parameter of the optical fiber, for example, a core diameter, a relative refractive index of the core portion with respect to the cladding portion, a refractive index profile of the core portion and the cladding portion and the like are exemplified.

The storage unit 12 previously stores a plurality of parameter sets that are known at the time of manufacture or sale of the fusion splicer 10. Due to this, these parameter sets are preset in the storage unit 12. The storage unit 12 also stores the classification model 33a for determining the type of the optical fiber provided from the learning processing device 30 (described later).

The control unit 13 sets, as a fusion condition, a parameter set adapted to fusion splicing of the pair of optical fibers among the parameter sets in the storage unit 12 in accordance with the respective types of the optical fibers, the transmission light wavelength and the like of the pair of optical fibers as a target of fusion splicing. The control unit 13 appropriately controls respective operations of the microscope unit, the axis aligning mechanism, the heating device, the feeding mechanism, and the reinforcing mechanism in the series of steps performed by the functional unit 11 described above based on respective parameters in the set parameter set. On the other hand, in a case in which the adapted parameter set described above is not preset in the storage unit 12, the control unit 13 sets a new parameter set that is acquired from the learning processing device 30 (described later) via the network 2 as the fusion condition required for fusion splicing of the pair of optical fibers. The control unit 13 also controls input/output of a signal to/from the storage unit 12, the imaging unit 14, the image processing unit 15, the brightness profile extracting unit 16, the determination unit 17, the communication unit 18, the input unit 19, and the display unit 20, and respective operations thereof.

The imaging unit 14 images side view image data of the optical fiber. Specifically, the imaging unit 14 is constituted of a light source, an image sensor and the like. The imaging unit 14 emits light in the radial direction of the optical fiber from the light source for each of the pair of optical fibers set in the functional unit 11 of the fusion splicer 10, and detects light transmitted through the optical fiber with the image sensor. Due to this, the imaging unit 14 images image data viewed from the radial direction of the optical fiber, that is, side view image data (transmission image data) for each of the pair of optical fibers. The side view image data includes a contrast distribution (that is, a brightness profile) that is generated in the radial direction of the optical fiber due to a refractive-index difference of the core portion and the cladding portion of the optical fiber, air and the like.

The image processing unit 15 performs augmentation processing of augmenting the side view image data of the optical fiber to be a plurality of pieces of side view image data. Specifically, the image processing unit 15 performs augmentation processing on the side view image data of the optical fiber imaged by the imaging unit 14 to create a plurality of pieces of side view image data of the optical fiber. In the present embodiment, for example, the image processing unit 15 performs at least one of rotation, translation, flipping, adjustment of brightness, impartment of noise, and adjustment of focus on the image data, and performs augmentation processing on the side view image data of the optical fiber. Through such augmentation processing, the image processing unit 15 creates a plurality of pieces of side view image data having different states such as image data obtained by changing a position or orientation upward, downward, to the left, or to the right, image data obtained by changing brightness or contrast, and image data obtained by increasing noise for each piece of the side view image data of one optical fiber as a target. The pieces of side view image data obtained through the augmentation processing include original side view image data before the augmentation processing, and a plurality of new pieces of side view image data created from the original side view image data. The image processing unit 15 associates the pieces of side view image data obtained through the augmentation processing with one optical fiber as a target of this augmentation processing.

The brightness profile extracting unit 16 extracts brightness profile data of the optical fiber. Specifically, the brightness profile extracting unit 16 extracts the brightness profile data indicating brightness profile in the radial direction of the optical fiber based on the side view image data imaged by the imaging unit 14 from the radial direction of the optical fiber. Specifically, in a case in which the imaging unit 14 images the side view image data for each of the pair of optical fibers as a target of fusion splicing, the brightness profile extracting unit 16 extracts the brightness profile data indicating the brightness profile in the radial direction of the pair of optical fibers based on the side view image data imaged by the imaging unit 14 from the radial direction of the pair of optical fibers. In a case in which the image processing unit 15 performs augmentation processing on the side view image data of the optical fiber, the brightness profile extracting unit 16 extracts the brightness profile data of the optical fiber from each of the pieces of side view image data obtained through the augmentation processing, and acquires a brightness profile data group corresponding to the optical fiber. In the present embodiment, as the brightness profile data extracted by the brightness profile extracting unit 16, for example, exemplified is a luminance profile in the radial direction of the optical fiber and the like. The luminance profile indicates brightness profile with respect to a radial direction position of the optical fiber, and is represented by a shape (waveform) of a graph in which a horizontal axis indicates the radial direction position and a vertical axis indicates luminance, for example.

The determination unit 17 determines respective types of the optical fibers for the pair of optical fibers as a target of fusion splicing. Specifically, the determination unit 17 determines the respective types of the optical fibers for the pair of optical fibers using the classification model 33a based on the brightness profile data in the radial direction of the pair of optical fibers. In the present embodiment, the brightness profile data in the radial direction of the pair of optical fibers is extracted by the brightness profile extracting unit 16 based on the side view image data of the pair of optical fibers imaged by the imaging unit 14. The classification model 33a is created by a classification model creation unit 33 of the learning processing device 30 (described later), provided to the fusion splicer 10 from the learning processing device 30 via the network 2, for example, and stored in the storage unit 12.

The communication unit 18 communicates with the learning processing device 30. Specifically, the communication unit 18 receives the classification model 33a from the learning processing device 30 via the network 2, for example. On the other hand, in the present embodiment, the communication unit 18 transmits, to the learning processing device 30, the brightness profile data of the optical fiber extracted by the brightness profile extracting unit.

The input unit 19 is constituted of an input key and the like, and inputs various kinds of information in response to an input operation of a user or an operator. As the information input by the input unit 19, for example, exemplified are information related to the pair of optical fibers to be subjected to fusion splicing such as a transmission light wavelength, information for starting or stopping fusion splicing, information for designating an operation mode to be switchable and the like. According to the present embodiment, as the operation mode, exemplified are a machine learning mode for acquiring data required for machine learning for creating the classification model 33a, a fusion splicing mode for fusion-splicing the pair of optical fibers, a relearning mode for acquiring data required for machine learning (relearning) for updating the classification model 33a and the like. For example, the image processing unit 15 operates in the machine learning mode or the relearning mode. The determination unit 17 operates in the fusion splicing mode.

The display unit 20 is constituted of a display device such as a liquid crystal display, and displays various kinds of information instructed to be displayed by the control unit 13. As the information displayed by the display unit 20, for example, exemplified are information received by the communication unit 18 from the learning processing device 30, information transmitted from the communication unit 18 to the learning processing device 30, information input by the input unit 19 and the like. In the present embodiment, the network 2 is a communication network such as the Internet and a local area network (LAN), for example.

On the other hand, as illustrated in FIG. 1, the learning processing device 30 is a device that performs learning processing and the like for creating the classification model 33a to be provided to the fusion splicer 10. For example, the learning processing device 30 is constituted of a computer such as a server and a workstation, and includes a communication unit 31, a data editing unit 32, and a classification model creation unit 33 as illustrated in FIG. 1.

The communication unit 31 communicates with the fusion splicer 10 and each fusion splicer of the group of fusion splicers 10A. In the present embodiment, the communication unit 31 communicates with the communication unit 18 of the fusion splicer 10 via the network 2, and due to this, transmits the classification model 33a to the communication unit 18 of the fusion splicer 10, for example. The communication unit 31 also communicates with the communication unit 18 of each fusion splicer of the group of fusion splicers 10A, and due to this, receives the brightness profile data of the optical fiber for each type of the optical fiber from the communication unit 18 of each fusion splicer, for example.

The data editing unit 32 creates teacher data used for machine learning for creating the classification model 33a. In the present embodiment, the data editing unit 32 creates the teacher data indicating a correspondence relationship between the type of the optical fiber and the brightness profile in the radial direction of the optical fiber based on the brightness profile data of the optical fiber extracted by the brightness profile extracting unit 16 of each fusion splicer of the group of fusion splicers 10A.

The classification model creation unit 33 creates the classification model 33a for determining the type of the optical fiber for each of the pair of optical fibers as a target of fusion splicing. Specifically, the classification model creation unit 33 performs machine learning by using the teacher data created by the data editing unit 32, and due to this, creates the classification model 33a. The classification model 33a can determine the type of the optical fiber for an arbitrary optical fiber based on the brightness profile data indicating brightness profile in the radial direction of the arbitrary optical fiber. In the present embodiment, as machine learning performed by the classification model creation unit 33, exemplified is supervised learning using a support vector machine, logistic regression, a neural network, and a method such as deep learning, for example.

The storage device 40 is a storage device having a large capacity that stores various kinds of information in an updatable manner. Specifically, as illustrated in FIG. 1, the storage device 40 includes a brightness profile database 41 and a fusion condition database 42.

The brightness profile database 41 is a database associating the type of the optical fiber with the brightness profile data of the optical fiber that is collected by the data editing unit 32 from each fusion splicer of the group of fusion splicers 10A via the communication unit 31 to be accumulated therein. The storage device 40 associates the teacher data and the brightness profile data of a plurality of optical fibers used for machine learning with the types of the optical fibers for the above optical fibers to be stored in the brightness profile database 41.

The fusion condition database 42 is a database associating a plurality of fusion conditions (parameter sets) with respective combinations of the types of the optical fibers of the pair of optical fibers having a track record of fusion splicing to be accumulated therein. The storage device 40 stores the fusion conditions in the fusion condition database 42 for each combination of the types of the optical fibers of the pair of optical fibers having a track record of fusion splicing.

Respective Parameters of Fusion Condition

Next, the following describes respective parameters of the fusion conditions that are respectively set in the fusion splicer 10 and each fusion splicer of the group of fusion splicers 10A according to the embodiment of the present invention in detail. In the following description, the fusion splicer 10 on the user side is exemplified to explain the respective parameters of the fusion conditions, but note that the parameters of the fusion conditions are the same between the fusion splicer 10 on the user side and the group of fusion splicers 10A on the manufacturer side.

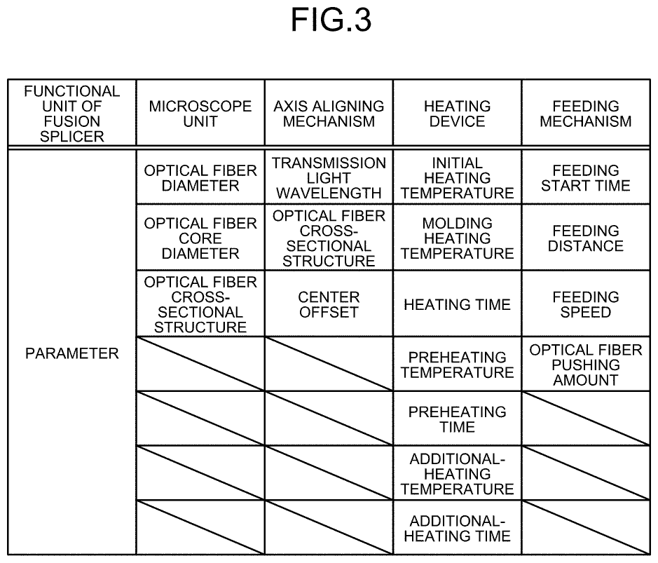

In fusion-splicing the optical fibers by the functional unit 11 of the fusion splicer 10, the control unit 13 controls the functional unit 11 based on the respective parameters of the fusion condition (parameter set) set in the fusion splicer 10. FIG. 3 is a diagram illustrating an example of the respective parameters of the fusion condition used for the functional unit of the fusion splicer according to the embodiment of the present invention. As illustrated in FIG. 3, in the fusion splicer 10, the parameters of the fusion condition are set for each of the microscope unit, the axis aligning mechanism, the heating device, and the feeding mechanism constituting the functional unit 11, for example.

Specifically, as illustrated in FIG. 3, for example, an optical fiber diameter, an optical fiber core diameter, and an optical fiber cross-sectional structure are used as the parameters for the microscope unit of the functional unit 11. The control unit 13 reads out these parameters from the storage unit 12 of the fusion splicer 10, and controls an operation of the microscope unit such as image processing at the position recognition step and the inspection step described above based on the read-out parameters.

As illustrated in FIG. 3, for example, a transmission light wavelength, an optical fiber cross-sectional structure, and a center offset are used as the parameters for the axis aligning mechanism of the functional unit 11. The center offset is an adjustment amount of the positions of the end parts of the respective optical fibers to be butted against each other at the time of fusion splicing of the optical fibers (hereinafter, referred to as a butting position). The end parts of the respective optical fibers to be fusion-spliced are, typically, separated from each other at regular intervals around a discharge band of the heating device that heats and melts the end parts. However, the butting position may be adjusted (offset) depending on a combination of the pair of optical fibers to be fusion-spliced. The control unit 13 reads out these parameters from the storage unit 12, and controls the operation of the axis aligning mechanism at the axis alignment step described above based on the read-out parameters.

As illustrated in FIG. 3, for example, an initial heating temperature, a molding heating temperature, a heating time, a preheating temperature, a preheating time, an additional-heating temperature, and an additional-heating time are used as the parameters for the heating device of the functional unit 11. The fusion-spliced portion of the optical fibers (for example, the fusion-spliced portion of the optical fibers having different core diameters) may be additionally heated after fusion splicing ends. Heat processing performed at this point is called additional heating, the additional-heating temperature is a heating temperature for the additional heating, and the additional-heating time is a heating time for the additional heating. The control unit 13 reads out these parameters from the storage unit 12, and controls the operation of the heating device at the heating step described above based on the read-out parameters.

As illustrated in FIG. 3, for example, a feeding start time, a feeding distance, a feeding speed, and an optical fiber pushing amount are used as the parameters for the feeding mechanism of the functional unit 11. The control unit 13 reads out these parameters from the storage unit 12, and controls the operation of the feeding mechanism at the splicing step described above based on the read-out parameters.

In the present embodiment, the fusion condition (parameter set) including the respective parameters exemplified in FIG. 3 is preset in the fusion splicer 10 (that is, stored in the storage unit 12) for each combination of the types of the optical fibers of the pair of optical fibers. The fusion condition according to the present embodiment is not limited to the fusion condition including the parameters illustrated in FIG. 3, and may further include parameters other than those illustrated in FIG. 3, for example, parameters for the reinforcing mechanism that performs the reinforcing step described above and the like.

Creation of Classification Model

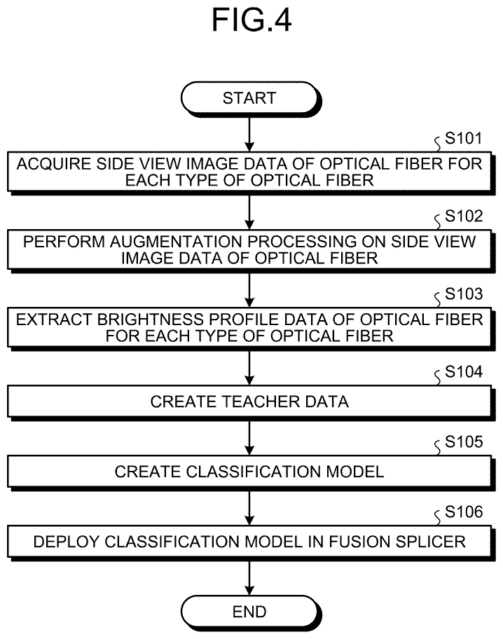

Next, the following describes a processing procedure of creating and disposing the classification model 33a for determining the type of the optical fiber for each of the pair of optical fibers as a target of fusion splicing performed by the fusion splicing system 1 according to the present embodiment. FIG. 4 is a flowchart illustrating an example of the processing procedure at the time of creating the classification model of the type of the optical fiber to be deployed in the fusion splicer according to the embodiment of the present invention. In the fusion splicing system 1 according to the present embodiment, the learning processing device 30 creates the classification model 33a for determining the type of the optical fiber for each of the pair of optical fibers as a target of fusion splicing to be deployed in the fusion splicer 10 by performing the respective processing steps illustrated in FIG. 4.

Specifically, as illustrated in FIG. 4, in the fusion splicing system 1, first, the imaging unit 14 acquires the side view image data of the optical fiber for each type of the optical fiber (Step S101). At Step S101, the optical fiber as a target of imaging is set in the functional unit 11. The control unit 13 controls the imaging unit 14 to image the set optical fiber. The imaging unit 14 images the side view image data of the optical fiber based on the control performed by the control unit 13.

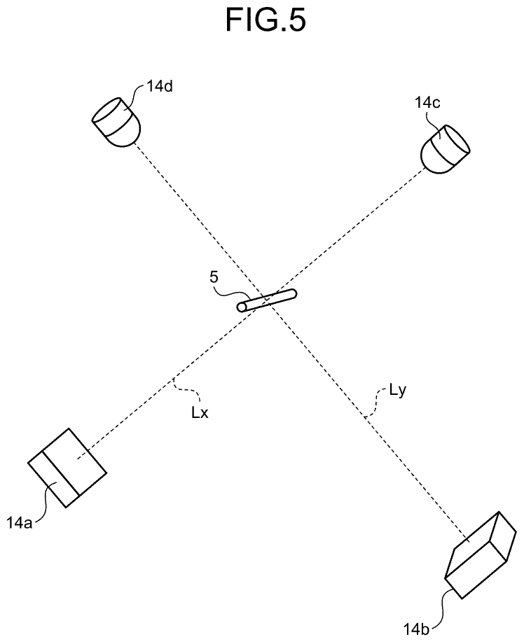

FIG. 5 is a diagram illustrating imaging of the side view image data of the optical fiber according to the embodiment of the present invention. In FIG. 5, an optical fiber 5 is an optical fiber as a target of imaging, and is set in the functional unit 11 (not illustrated in FIG. 5). Image sensors 14a and 14b, and light sources 14c and 14d are included in each imaging unit 14 of the fusion splicer 10 and the group of fusion splicers 10A in the present embodiment.

As illustrated in FIG. 5, the image sensors 14a and 14b are disposed so that respective optical axes Lx and Ly thereof intersect at right angles. That is, the optical axis Lx of the image sensor 14a is parallel with an X-axis of a three-axis orthogonal coordinate system, and the optical axis Ly of the image sensor 14b is parallel with a Y-axis of the three-axis orthogonal coordinate system. A center axis direction (longitudinal direction) of the optical fiber 5 is parallel with a Z-axis of the three-axis orthogonal coordinate system. The image sensor 14a and the light source 14c are configured so that light emitted from the light source 14c is transmitted through the optical fiber 5 in the radial direction (a direction of the optical axis Lx) to be received by the image sensor 14a. The image sensor 14b and the light source 14d are configured so that light emitted from the light source 14d is transmitted through the optical fiber 5 in the radial direction (a direction of the optical axis Ly) to be received by the image sensor 14b. For example, the imaging unit 14 can image the side view image data in the X-axis direction and the side view image data in the Y-axis direction of the optical fiber 5 with the image sensors 14a and 14b.

At Step S101, as described above, the imaging unit 14 acquires a predetermined number of (two in the example of FIG. 5) pieces of side view image data corresponding to the type of the optical fiber for the optical fiber as a target. In the present embodiment, the functional unit 11, the control unit 13, and the imaging unit 14 in such processing at Step S101 are included in each fusion splicer of the group of fusion splicers 10A set in the machine learning mode.

After performing Step S101, in the fusion splicing system 1, the image processing unit 15 performs augmentation processing on the side view image data of the optical fiber (Step S102). At Step S102, the image processing unit 15 acquires, from the imaging unit 14, the side view image data of the optical fiber imaged at Step S101 described above for each type of the optical fiber. The image processing unit 15 performs at least one piece of image processing such as rotation, translation, flipping, adjustment of brightness, impartment of noise, and adjustment of focus on the side view image data acquired from the imaging unit 14. Due to this, the image processing unit 15 performs augmentation processing on the side view image data to create a plurality of pieces of side view image data of the optical fiber (specifically, an optical fiber as a subject of the imaging unit 14 at Step S101). In the present embodiment, these pieces of side view image data are a group of pieces of image data corresponding to the type of the optical fiber of this optical fiber, and include the original side view image data before the augmentation processing.

In this case, in the augmentation processing performed by the image processing unit 15, adjustment of focus is performed by using an optical simulation that simulates imaging of the side view image data of the optical fiber performed by the imaging unit 14. Specifically, the optical simulation simulates imaging of the side view image data of the optical fiber 5 performed by the image sensors 14a and 14b and the light sources 14c and 14d illustrated in FIG. 5, for example. The image processing unit 15 uses the optical simulation to adjust focus by changing a distance from the image sensors 14a and 14b to the optical fiber 5 so that a structure parameter (internal structure) of the optical fiber 5 represented in the side view image data are gradually changed, and analyzes the side view image data obtained through the adjustment. Based on the analysis result, the image processing unit 15 creates a plurality of pieces of side view image data to statistically include variations in the structure parameter (that is, manufacturing variations) of the optical fiber 5 and an individual difference of the imaging unit 14 that images the side view image data of the optical fiber 5 (that is, an individual difference of the optical system of the fusion splicer).

In the present embodiment, it is preferable that the image processing unit 15 perform augmentation processing including at least the adjustment of focus. The image processing unit 15 in such processing at Step S102 is included in each fusion splicer of the group of fusion splicers 10A set in the machine learning mode.

After performing Step S102, in the fusion splicing system 1, the brightness profile extracting unit 16 extracts the brightness profile data of the optical fiber for each type of the optical fiber (Step S103). At Step S103, the brightness profile extracting unit 16 extracts the brightness profile data indicating brightness profile in the radial direction of the optical fiber based on the side view image data imaged from the radial direction of the optical fiber at Step S101 described above.

Specifically, the brightness profile extracting unit 16 collects, from the image processing unit 15, the pieces of side view image data of the optical fiber obtained through the augmentation processing at Step S102 described above for each type of the optical fiber of this optical fiber. The brightness profile extracting unit 16 extracts the brightness profile data of this optical fiber from each of the pieces of side view image data collected from the image processing unit 15.

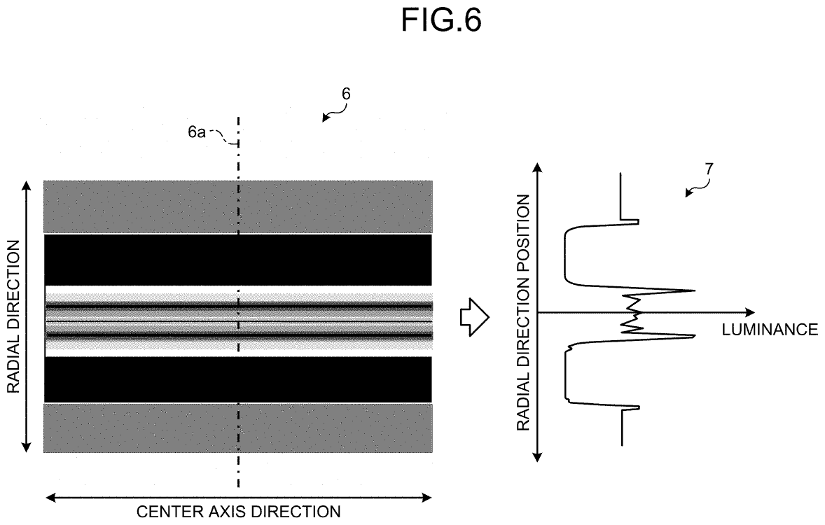

FIG. 6 is a diagram illustrating extraction of the brightness profile data of the optical fiber according to the embodiment of the present invention. In FIG. 6, a “radial direction” means the radial direction of the optical fiber, and a “center axis direction” means the center axis direction (longitudinal direction) of the optical fiber. Side view image data 6 is an example of the side view image data of the optical fiber imaged by the imaging unit 14. The side view image data 6 is image data including brightness profile in the radial direction of the optical fiber. The brightness profile included in the side view image data 6 is different for each type of the optical fiber.

In the present embodiment, as illustrated in FIG. 6 for example, the brightness profile extracting unit 16 performs image processing on a portion at a predetermined center axis direction position 6a in the side view image data 6 of the optical fiber, and extracts a luminance profile 7 indicating the brightness profile in the radial direction of this optical fiber accordingly. That is, the brightness profile data of the optical fiber according to the present embodiment are data of the luminance profile of the optical fiber exemplified in the luminance profile 7. The brightness profile extracting unit 16 performs such processing of extracting the luminance profile 7 from the side view image data 6 for each of the pieces of side view image data for each type of the optical fiber collected from the image processing unit 15. As described above, the brightness profile extracting unit 16 acquires a plurality of luminance profiles as the brightness profile data of the optical fiber for each type of the optical fiber corresponding to the pieces of side view image data. The brightness profile extracting unit 16 in such processing at Step S103 is included in each fusion splicer of the group of fusion splicers 10A set in the machine learning mode.

After performing Step S103, in the fusion splicing system 1, the data editing unit 32 of the learning processing device 30 creates teacher data used for machine learning for creating the classification model 33a (Step S104). At Step S104, the communication unit 31 of the learning processing device 30 receives, from the communication unit 18 of each fusion splicer of the group of fusion splicers 10A, the brightness profile data that is extracted for each type of the optical fiber by the brightness profile extracting unit 16 at Step S103 described above. The data editing unit 32 collects the brightness profile data from the brightness profile extracting unit 16 for each type of the optical fiber via the communication unit 31. The data editing unit 32 creates the teacher data to indicate a correspondence relationship between the brightness profile in the radial direction of the optical fiber and the type of the optical fiber based on the brightness profile data of the optical fiber collected for each type of the optical fiber. In the present embodiment, the created teacher data are a data set indicating a correspondence relationship between the luminance profile indicating brightness profile in the radial direction of the optical fiber and the type of the optical fiber as the correspondence relationship between the brightness profile in the radial direction of the optical fiber and the type of the optical fiber.

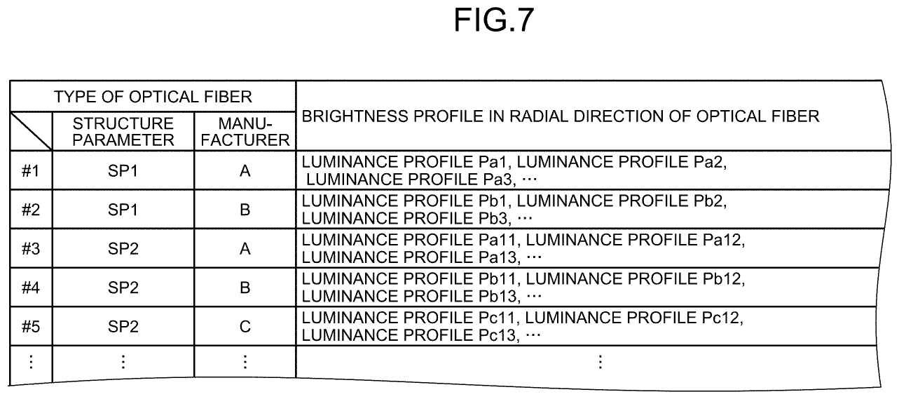

FIG. 7 is a diagram illustrating an example of the teacher data used for machine learning according to the embodiment of the present invention. In the present embodiment, the data editing unit 32 creates, for example, the teacher data as illustrated in FIG. 7 based on the luminance profile collected for each type of the optical fiber as the brightness profile data described above. The teacher data indicate the correspondence relationship between the brightness profile in the radial direction of the optical fiber and the type of the optical fiber using the luminance profile for each type of the optical fiber. In FIG. 7, structure parameters SP1 and SP2 represent structure parameters of optical fibers different from each other (a core diameter, a relative refractive index, a refractive index profile and the like of the optical fiber). Manufacturers A, B, and C represent respective manufacturers of the optical fibers different from each other.

For example, as illustrated in FIG. 7, in the teacher data, the type of the optical fiber #1 defined by “the structure parameter SP1 and the manufacturer A” is associated with luminance profiles (Pa1, Pa2, Pa3, . . . ) and the like extracted from the side view image data of the optical fiber of this type of the optical fiber #1. The type of the optical fiber #2 defined by “the structure parameter SP1 and the manufacturer B” is associated with luminance profiles (Pb1, Pb2, Pb3, . . . ) and the like extracted from the side view image data of the optical fiber of this type of the optical fiber #2. The type of the optical fiber #3 defined by “the structure parameter SP2 and the manufacturer A” is associated with luminance profiles (Pa11, Pa12, Pa13, . . . ) and the like extracted from the side view image data of the optical fiber of this type of the optical fiber #3. The type of the optical fiber #4 defined by “the structure parameter SP2 and the manufacturer B” is associated with luminance profiles (Pb11, Pb12, Pb13, . . . ) and the like extracted from the side view image data of the optical fiber of this type of the optical fiber #4. The type of the optical fiber #5 defined by “the structure parameter SP2 and the manufacturer C” is associated with luminance profiles (Pc11, Pc12, Pc13, . . . ) and the like extracted from the side view image data of the optical fiber of this type of the optical fiber #5.

The data editing unit 32 uses part of the brightness profile data collected for each type of the optical fiber for creating the teacher data described above, accumulates part thereof as an evaluation data for machine learning, and accumulates part thereof as test data for machine learning. The brightness profile data group for each type of the optical fiber are stored in the brightness profile database 41 of the storage device 40 while being associated with the type of the optical fiber.

After performing Step S104, in the fusion splicing system 1, the classification model creation unit 33 of the learning processing device 30 creates the classification model 33a for determining the type of the optical fiber for each of the pair of optical fibers as a target of fusion splicing (Step S105). At Step S105, the classification model creation unit 33 acquires, from the data editing unit 32, the teacher data, the evaluation data, and the test data created at Step S104 described above. The classification model creation unit 33 performs machine learning by using the acquired teacher data, and creates, from the brightness profile data indicating brightness profile in the radial direction of an arbitrary optical fiber, the classification model 33a that can determine the type of the optical fiber of the arbitrary optical fiber.

At this point, the classification model creation unit 33 performs machine learning in accordance with a predetermined machine learning algorithm using the teacher data described above. In this machine learning, the classification model creation unit 33 reduces the number of dimensions of the brightness profile data acquired from the data editing unit 32 as needed by using an algorithm of principal component analysis and the like, for example, and extracts a characteristic amount of the brightness profile data of the optical fiber. Subsequently, the classification model creation unit 33 focuses on a characteristic portion including the characteristic amount described above in the brightness profile data of the optical fiber, and learns a correspondence relationship between the luminance profile in the radial direction of the optical fiber and the type of the optical fiber. That is, without clearly indicating a portion to be focused on in the brightness profile data described above by a person, the classification model creation unit 33 automatically selects the characteristic portion having an appropriate characteristic amount from the brightness profile data described above, and focuses on the selected characteristic portion to perform the machine learning described above. The classification model creation unit 33 creates the classification model 33a by performing machine learning in this way. In the present embodiment, as the machine learning performed by the classification model creation unit 33, exemplified is supervised learning using a support vector machine, logistic regression, a neural network, a method such as deep learning, for example.

The classification model creation unit 33 improves determination accuracy of the classification model 33a created as described above by learning using the evaluation data. Subsequently, the classification model creation unit 33 causes the classification model 33a after learning to determine the type of the optical fiber with the test data. Due to this, the classification model creation unit 33 checks whether the type of the optical fiber of the arbitrary optical fiber is correctly determined based on the brightness profile data (in the present embodiment, the luminance profile) in the radial direction of the arbitrary optical fiber by the classification model 33a, and causes the classification model 33a to be able to determine the type of the optical fiber described above with high accuracy.

After performing Step S105, in the fusion splicing system 1, the learning processing device 30 deploys the classification model 33a in the fusion splicer 10 on the user side (Step S106), and this processing ends. At Step S106, the communication unit 31 of the learning processing device 30 acquires the classification model 33a created at Step S105 described above from the classification model creation unit 33, and transmits (provides) the acquired classification model 33a to the fusion splicer 10 via the network 2. The communication unit 18 of the fusion splicer 10 receives the classification model 33a via the network 2. The storage unit 12 acquires the classification model 33a from the communication unit 18 to be stored therein. In this way, the classification model 33a created by the classification model creation unit 33 is deployed in the fusion splicer 10.

Fusion Splicing of Pair of Optical Fibers

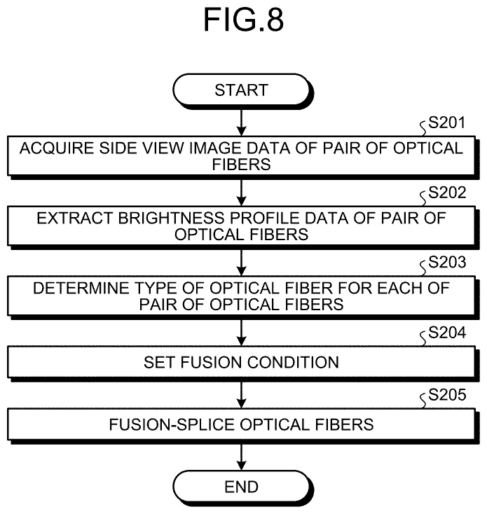

Next, the following describes a processing procedure of fusion splicing of the pair of optical fibers as a target of fusion splicing performed by the fusion splicing system 1 according to the present embodiment. FIG. 8 is a flowchart illustrating an example of the processing procedure at the time of fusion-splicing the pair of optical fibers as a target of fusion splicing according to the embodiment of the present invention. In the following description, one of the pair of optical fibers to be fusion-spliced (hereinafter, appropriately abbreviated as a “pair of optical fibers”) is appropriately referred to as an optical fiber F1, and the other one thereof is appropriately referred to as an optical fiber F2. In the fusion splicing system 1 according to the present embodiment, through the processing steps illustrated in FIG. 8, the type of the optical fiber is determined for each of the pair of optical fibers as a target of fusion splicing, the fusion condition is set in accordance with the determination result of the type of the optical fiber, and the pair of optical fibers are fusion-spliced based on the set fusion condition.

Specifically, as illustrated in FIG. 8, first, the imaging unit 14 acquires the side view image data of the pair of optical fibers as a target of fusion splicing in the fusion splicing system 1 (Step S201). At Step S201, the pair of optical fibers as a target of fusion splicing is set in the functional unit 11. The control unit 13 controls the imaging unit 14 to image the set pair of optical fibers. The imaging unit 14 images the side view image data of the pair of optical fibers (for example, the side view image data in a state in which end faces of the one optical fiber F1 and the other optical fiber F2 are opposed to each other) based on the control by the control unit 13. At this point, the imaging unit 14 may image the side view image data described above using both of the two image sensors 14a and 14b illustrated in FIG. 5, and may also image the side view image data described above using any one of these image sensors 14a and 14b. It is sufficient that the imaging unit 14 images the side view image data described above once for the pair of optical fibers. In the present embodiment, the functional unit 11, the control unit 13, and the imaging unit 14 in the processing at Step S201 are included in the fusion splicer 10 set in the fusion splicing mode.

After performing Step S201, in the fusion splicing system 1, the brightness profile extracting unit 16 extracts the brightness profile data of the pair of optical fibers (Step S202). At Step S202, the brightness profile extracting unit 16 acquires, from the imaging unit 14, the side view image data that is imaged from the radial direction of the pair of optical fibers at Step S201 described above. The brightness profile extracting unit 16 extracts the brightness profile data indicating brightness profile in the radial direction of the pair of optical fibers based on the side view image data acquired from the imaging unit 14.

In the present embodiment, the brightness profile data of the pair of optical fibers extracted at Step S202 are data of the luminance profile indicating the brightness profile in the radial direction of the pair of optical fibers. Specifically, the brightness profile extracting unit 16 extracts the side view image data of the one optical fiber F1 and the side view image data of the other optical fiber F2 from the side view image data of the pair of optical fibers acquired from the imaging unit 14. Subsequently, the brightness profile extracting unit 16 performs predetermined image processing on a portion at a predetermined center axis direction position in the respective pieces of extracted side view image data, and extracts the luminance profile indicating the brightness profile in the radial direction of the one optical fiber F1 and the luminance profile indicating the brightness profile in the radial direction of the other optical fiber F2. In the present embodiment, the brightness profile extracting unit 16 in the processing at Step S202 is included in the fusion splicer 10 set in the fusion splicing mode.

After performing Step S202, in the fusion splicing system 1, the determination unit 17 determines the type of the optical fiber for each of the pair of optical fibers using the classification model 33a described above based on the brightness profile data that are extracted based on the side view image data of the pair of optical fibers as a target of fusion splicing (Step S203).

At Step S203, the determination unit 17 reads out, from the storage unit 12, the classification model 33a that is deployed in the fusion splicer 10 at Step S106 illustrated in FIG. 4. The determination unit 17 also acquires, from the brightness profile extracting unit 16, the brightness profile data of the pair of optical fibers extracted at Step S202 described above, that is, the brightness profile data of each of the optical fibers F1 and F2. Subsequently, the determination unit 17 determines the type of the optical fiber for the optical fiber F1 using the classification model 33a based on the brightness profile data (in the present embodiment, the luminance profile) of the optical fiber F1. Subsequently, the determination unit 17 determines the type of the optical fiber for the optical fiber F2 using the classification model 33a based on the brightness profile data (in the present embodiment, the luminance profile) of the optical fiber F2. In the present embodiment, the determination unit 17 in the processing at Step S203 is included in the fusion splicer 10 set in the fusion splicing mode.

After performing Step S203, in the fusion splicing system 1, the control unit 13 sets the fusion condition for the pair of optical fibers (Step S204). At Step S204, the control unit 13 sets the fusion condition adapted to fusion splicing of the pair of optical fibers in accordance with a combination of the respective types of the optical fibers of the pair of optical fibers that is determined by the determination unit 17 at Step S203 described above. Specifically, the control unit 13 selects and reads out the fusion condition corresponding to the combination of the types of the optical fibers of the respective optical fibers F1 and F2 from among the fusion conditions stored in the storage unit 12. Subsequently, the control unit 13 sets the read-out fusion condition as the fusion condition adapted to fusion splicing of the optical fibers F1 and F2. In the present embodiment, the control unit 13 in the processing at Step S204 is included in the fusion splicer 10 set in the fusion splicing mode.

After performing Step S204, in the fusion splicing system 1, the functional unit 11 fusion-splices the pair of optical fibers as a target of fusion splicing (Step S205), and this processing ends. At Step S205, the functional unit 11 fusion-splices the pair of optical fibers based on the fusion condition set at Step S204 described above.

Specifically, the functional unit 11 successively performs the series of steps including the position recognition step, the axis alignment step, the heating step, the splicing step and the like described above for the pair of optical fibers based on the control by the control unit 13. Due to this, the functional unit 11 fusion-splices the pair of optical fibers described above, that is, the optical fibers F1 and F2. In the present embodiment, the functional unit 11 in the processing at Step S205 is included in the fusion splicer 10 set in the fusion splicing mode.

Update of Classification Model

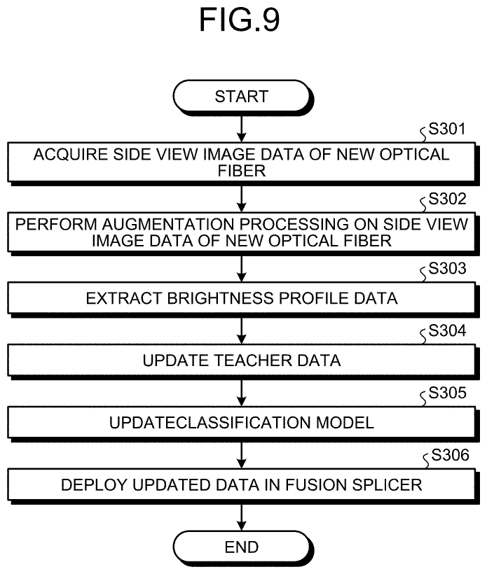

Subsequently, the following describes a processing procedure of updating and deploying the classification model 33a for determining the type of the optical fiber for each of the pair of optical fibers as a target of fusion splicing performed by the fusion splicing system 1 according to the present embodiment. FIG. 9 is a flowchart illustrating an example of the processing procedure at the time of updating the classification model of the type of the optical fiber to be deployed in the fusion splicer according to the embodiment of the present invention. In the fusion splicing system 1 according to the present embodiment, through the processing steps illustrated in FIG. 9, the classification model 33a for determining the type of the optical fiber of each of the pair of optical fibers as a target of fusion splicing is updated by the learning processing device 30 and deployed in the fusion splicer 10.

Specifically, as illustrated in FIG. 9, first, the imaging unit 14 acquires side view image data of a new optical fiber in the fusion splicing system 1 (Step S301). At Step S301, the new optical fiber as a target of imaging is set in the functional unit 11. The new optical fiber means an optical fiber the type of which is new and different from the type of the optical fiber in the past, that is, an optical fiber having a new combination of the structure parameter and the manufacturer for determining the type of the optical fiber. The control unit 13 controls the imaging unit 14 so as to image the new optical fiber that is set. The imaging unit 14 images the side view image data of this new optical fiber based on the control by the control unit 13.

A method of imaging the side view image data of the new optical fiber performed by the imaging unit 14 at Step S301 is the same as the method of imaging at Step S101 illustrated in FIG. 4. In the present embodiment, the functional unit 11, the control unit 13, and the imaging unit 14 in such processing at Step S301 are included in any one of the group of fusion splicers 10A set in the relearning mode.

After performing Step S301, in the fusion splicing system 1, the image processing unit 15 performs augmentation processing on the side view image data of the new optical fiber (Step S302). At Step S302, the image processing unit 15 acquires, from the imaging unit 14, the side view image data of the new optical fiber imaged at Step S301 described above. The image processing unit 15 performs augmentation processing on the side view image data acquired from the imaging unit 14 to create a plurality of pieces of side view image data corresponding to the type of the optical fiber of the new optical fiber. A method of augmentation processing for the side view image data of the new optical fiber performed by the image processing unit 15 at Step S302 is the same as the method of augmentation processing at Step S102 illustrated in FIG. 4.

In the present embodiment, also at Step S302, it is preferable that the image processing unit 15 perform augmentation processing including at least adjustment of focus similarly to Step S102 described above. The image processing unit 15 in such processing at Step S302 is included in any one of the group of fusion splicers 10A set in the relearning mode.

After performing Step S302, in the fusion splicing system 1, the brightness profile extracting unit 16 extracts the brightness profile data of the new optical fiber (Step S303). At Step S303, the brightness profile extracting unit 16 extracts the brightness profile data indicating brightness profile in the radial direction of the new optical fiber based on the side view image data that is imaged from the radial direction of the new optical fiber at Step S301 described above.

Specifically, the brightness profile extracting unit 16 collects, from the image processing unit 15, a plurality of pieces of side view image data of the new optical fiber obtained through the augmentation processing at Step S302 described above. The brightness profile extracting unit 16 extracts the brightness profile data of the new optical fiber from each of the pieces of side view image data collected from the image processing unit 15. A method of extracting the brightness profile data of the new optical fiber performed by the brightness profile extracting unit 16 at Step S303 is the same as the extraction method at Step S103 illustrated in FIG. 4. In the present embodiment, for example, the brightness profile extracting unit 16 extracts a luminance profile indicating brightness profile in the radial direction of the new optical fiber from each of the pieces of side view image data. Due to this, the brightness profile extracting unit 16 acquires a data group of the luminance profile corresponding to the type of the optical fiber of the new optical fiber. The brightness profile extracting unit 16 in such processing at Step S303 is included in any one of the group of fusion splicers 10A set in the relearning mode.

After performing Step S303, in the fusion splicing system 1, the data editing unit 32 of the learning processing device 30 updates the teacher data created at Step S104 illustrated in FIG. 4 (Step S304).

At Step S304, the communication unit 31 of the learning processing device 30 receives, from the communication unit 18 of any one of the group of fusion splicers 10A, the brightness profile data of the new optical fiber extracted by the brightness profile extracting unit 16 at Step S303 described above. The data editing unit 32 collects the brightness profile data of the new optical fiber described above from the brightness profile extracting unit 16 via the communication unit 31. The data editing unit 32 also reads out, from the storage device 40, the brightness profile data group for each type of the optical fiber that has been accumulated in the brightness profile database 41 up to this point. The data editing unit 32 adds, to the brightness profile data group (accumulated data group) for each type of the optical fiber, the brightness profile data of the new optical fiber collected as described above (for example, a data group of the luminance profile). Due to this, the data editing unit 32 updates the brightness profile data group for each type of the optical fiber to be a data group newly including the brightness profile data associated with the type of the optical fiber of the new optical fiber described above. Subsequently, the data editing unit 32 updates the teacher data obtained at Step S104 described above based on the brightness profile data group for each type of the optical fiber that has been updated as described above.

That is, in the present embodiment, in a case in which the imaging unit 14 of the fusion splicer (one of the group of fusion splicers 10A) in the relearning mode images the side view image data of the new optical fiber, the teacher data are updated by adding the brightness profile data extracted by the brightness profile extracting unit 16 to the side view image data of the new optical fiber. This updated teacher data are a data set indicating a correspondence relationship between the type of the optical fiber and the brightness profile in the radial direction of the new optical fiber in addition to the correspondence relationship between the type of the optical fiber and the brightness profile in the radial direction of the existing optical fiber.

The data editing unit 32 uses part of the brightness profile data group for each type of the optical fiber that is updated as described above for creating (updating) the teacher data described above, accumulates part thereof as the evaluation data for machine learning, and accumulates part thereof as the test data for machine learning. The brightness profile data group for each type of the optical fiber are stored in the brightness profile database 41 of the storage device 40 while being associated with the type of the optical fiber.

After performing Step S304, in the fusion splicing system 1, the classification model creation unit 33 of the learning processing device 30 updates the classification model 33a created at Step S105 illustrated in FIG. 4 (Step S305). At Step S305, the classification model creation unit 33 acquires, from the data editing unit 32, the teacher data updated at Step S304 described above, the evaluation data, and the test data. The classification model creation unit 33 performs machine learning by using the acquired updated teacher data. Due to this, the classification model creation unit 33 updates the classification model 33a to be able to determine the type of the optical fiber of an arbitrary optical fiber based on the brightness profile data indicating brightness profile in the radial direction of the arbitrary optical fiber including the new optical fiber. At this point, the classification model creation unit 33 updates the classification model 33a by using the updated teacher data described above and performing machine learning in accordance with a predetermined machine learning algorithm similarly to Step S105 described above.

The classification model creation unit 33 also improves, through learning using the evaluation data, determination accuracy of the classification model 33a updated as described above. Subsequently, the classification model creation unit 33 causes the classification model 33a after learning to determine the type of the optical fiber with the test data. Due to this, the classification model creation unit 33 checks whether the type of the optical fiber of an arbitrary optical fiber is correctly determined based on the brightness profile data (in the present embodiment, the luminance profile) in the radial direction of the arbitrary optical fiber by the updated classification model 33a, and causes the updated classification model 33a to be able to determine the type of the optical fiber with high accuracy.

After performing Step S305, in the fusion splicing system 1, the learning processing device 30 deploys the updated data in the fusion splicer 10 on the user side (Step S306), and this processing ends. This updated data are a data group including at least the updated classification model 33a described above. In the present embodiment, this updated data include the updated classification model 33a described above and the fusion condition adapted to fusion splicing of the pair of optical fibers including the new optical fiber (hereinafter, appropriately referred to as a new parameter set). The new parameter set is previously created through an experiment and the like of fusion splicing using the new optical fiber, and is stored in the storage device 40 as part of the fusion condition database 42.

At Step S306, the communication unit 31 of the learning processing device 30 acquires the classification model 33a updated at Step S305 described above from the classification model creation unit 33. The communication unit 31 also reads out the new parameter set in the fusion condition database 42 from the storage device 40. The communication unit 31 transmits (provides) the updated data including the updated classification model 33a and the new parameter set to the fusion splicer 10 via the network 2. The communication unit 18 of the fusion splicer 10 receives the updated data via the network 2. The storage unit 12 acquires, from the communication unit 18, the updated data, that is, the updated classification model 33a and the new parameter set. The storage unit 12 updates the existing classification model 33a to be the acquired updated classification model 33a. The storage unit 12 also updates a plurality of existing parameter sets to be parameter sets each including the acquired new parameter set. In this way, the updated classification model 33a and the new parameter set are deployed in the fusion splicer 10.

In this case, the processing steps at Steps S101 to S106 illustrated in FIG. 4, the processing steps at Steps S201 to S203 illustrated in FIG. 8, and the processing steps at Steps S301 to S306 illustrated in FIG. 9 constitute the method of determining the type of the optical fiber according to the embodiment of the present invention. In the method of determining the type of the optical fiber, the respective processing steps at Steps S101 to S107 are performed in a case of creating the classification model 33a for determining the type of the optical fiber. The respective processing steps at Steps S201 to S203 are performed in a case in which the type of the optical fiber needs to be determined for each of the pair of optical fibers, for example, in a case of fusion-splicing the pair of optical fibers. The respective processing steps at Steps S301 to S306 are performed in a case of updating the classification model 33a.

As described above, in the embodiment of the present invention, the brightness profile data (in the present embodiment, the luminance profile) is extracted based on the side view image data of the optical fiber, the teacher data indicating the correspondence relationship between the type of the optical fiber and the brightness profile in the radial direction of the optical fiber are created based on the brightness profile data, machine learning is performed by using the teacher data, the classification model is created to be able to determine the type of the optical fiber for an arbitrary optical fiber based on the brightness profile data indicating brightness profile in the radial direction of the arbitrary optical fiber, and the type of the optical fiber is determined for each of the pair of optical fibers by using the classification model based on the brightness profile data that is extracted based on the side view image data of the pair of optical fibers as a target. Additionally, the fusion condition is set in accordance with a combination of respective determined types of optical fibers, and the pair of optical fibers are spliced (in the present embodiment, fusion-spliced) based on the set fusion condition.

Thus, an operator is not required to determine the type of the optical fiber for each of the pair of optical fibers that is set in the fusion splicer and the like to be actually spliced, and by imaging the side view image data of the set pair of optical fibers once, the brightness profile data of the pair of optical fibers can be extracted based on the side view image data that is once imaged, and the type of the optical fiber can be determined for each of the pair of optical fibers with high accuracy using the classification model based on the obtained brightness profile data. Due to this, time and effort for determining the type of the optical fiber for each of the pair of optical fibers as a target can be saved for the operator, and time required for determining the type of each optical fiber can be simply shortened. Additionally, the fusion condition adapted to fusion splicing of the pair of optical fibers can be simply set in accordance with a combination of determined types of optical fibers of the pair of optical fibers. Due to this, time and effort for selecting a correct fusion condition from among a large number of fusion conditions deployed in the fusion splicer can be saved for the operator, and time required for selecting the fusion condition can be simply shortened. Furthermore, time required for splicing (for example, fusion-splicing) the pair of optical fibers can be shortened.

By performing machine learning using the teacher data indicating the correspondence relationship between the type of the optical fiber and the brightness profile in the radial direction of the optical fiber, the classification model is created to be able to determine the type of the optical fiber for an arbitrary optical fiber based on the brightness profile data indicating the brightness profile in the radial direction of the arbitrary optical fiber, and the classification model is used for determining the type of the optical fiber for each of the pair of optical fibers. Thus, it is possible to determine the type of the optical fiber for each of the pair of optical fibers having an enormous number of combinations, and save time and effort for developing and deploying a determination program for determining the type of the optical fiber of a new optical fiber.

The side view image data of the optical fiber is subjected to augmentation processing, a plurality of pieces of side view image data corresponding to the type of the optical fiber are created, and the brightness profile data of the optical fiber required for machine learning for creating the classification model is extracted and collected from each of the pieces of side view image data. Due to this, the type of the optical fiber can be determined for each of the pair of optical fibers with high accuracy without being influenced by variations among manufacturing lots of the pair of optical fibers as a target or an individual difference of a device (specifically, an individual difference of an optical system) between fusion splicers. For example, even in a case of employing an optical system (imaging unit) constituted of an inexpensive image sensor, lens, and the like having relatively low performance for the fusion splicer, a robust classification model can be created by the machine learning described above, and the type of the optical fiber can be determined with high accuracy by using the classification model.

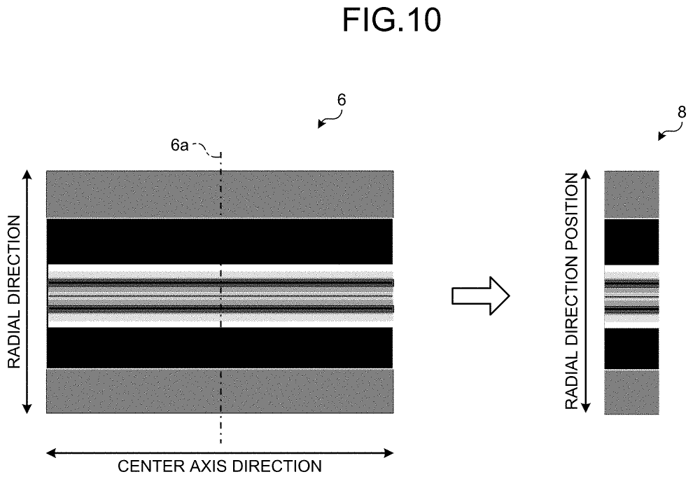

In the embodiment described above, the luminance profile is exemplified as an example of the brightness profile data indicating brightness profile in the radial direction of the optical fiber, but the present invention is not limited thereto. For example, the brightness profile data according to the present invention may be luminance image data indicating brightness profile in the radial direction of the optical fiber. FIG. 10 is a diagram exemplifying luminance image data as the brightness profile data indicating the brightness profile in the radial direction of the optical fiber according to the present invention. As illustrated in FIG. 10, for example, the brightness profile extracting unit 16 described above may perform image processing on a portion at the predetermined center axis direction position 6a in the side view image data 6 of the optical fiber, and extract luminance image data 8 indicating brightness profile with respect to the radial direction position of the optical fiber accordingly.

In the embodiment described above, the fusion splicer 10 or each fusion splicer of the group of fusion splicers 10A performs augmentation processing on the side view image data of the optical fiber and processing of extracting the brightness profile data from the side view image data of the optical fiber, but the present invention is not limited thereto. In the present invention, these augmentation processing and extraction processing may be performed by the learning processing device 30 (a server side). For example, an image processing unit and a brightness profile extracting unit respectively functioning similarly to the image processing unit 15 and the brightness profile extracting unit 16 described above may be disposed in the learning processing device 30, the side view image data of the optical fiber imaged by the imaging unit 14 may be subjected to augmentation processing performed by the image processing unit of the learning processing device 30, and the brightness profile data of the optical fiber may be extracted by the brightness profile extracting unit of the learning processing device 30. In this case, the image processing unit 15 is not necessarily disposed in the fusion splicer.

In the embodiment described above, exemplified is the fusion splicing system 1 including a plurality of fusion splicers (the fusion splicer 10 on the user side and the group of fusion splicers 10A on the manufacturer side), but the present invention is not limited thereto. For example, the fusion splicing system 1 according to the present invention may include a single fusion splicer, or may include a plurality of (two or more) fusion splicers. The single fusion splicer may be a fusion splicer on the user side, or may be a fusion splicer on the manufacturer side. Similarly, the fusion splicers may be fusion splicers on the user side, may be fusion splicers on the manufacturer side, or may be splicers including fusion splicers on the user side and fusion splicers on the manufacturer side.

In the embodiment described above, exemplified is the method of determining the type of the optical fiber for determining the type of the optical fiber for each of the pair of optical fibers as a target of fusion splicing, but the present invention is not limited thereto. In the method of determining the type of the optical fiber according to the present invention, the optical fiber the type of the optical fiber of which is determined may be a pair of optical fibers as a target of processing other than fusion splicing, for example, butting of end faces thereof and the like.

In the embodiment described above, exemplified is a case in which the fusion splicer 10 communicates with the learning processing device 30 via the network 2, but the present invention is not limited thereto. For example, the communication unit 18 of the fusion splicer 10 and the communication unit 31 of the learning processing device 30 may be configured to communicate with each other in a wired or wireless manner, and the fusion splicer 10 and the learning processing device 30 may communicate with each other without using the network 2. The fusion splicer 10 may directly communicate with the learning processing device 30 or communicate with the learning processing device 30 via the network 2 via a communication device different from the communication unit 18 (for example, an information communication device such as a smartphone and a tablet device).

As described above, the fusion splicing system, the fusion splicer, and the method of determining the type of the optical fiber according to the present invention are preferably applied to a field of optical fibers.

The present invention is not limited by the embodiment described above. The present invention encompasses a configuration obtained by appropriately combining the constituent elements described above.

Those skilled in the art can easily conceive additional effects and modifications. Thus, a broader aspect of the present invention is not limited to the specific details and the representative embodiment as represented and described above. Accordingly, various modification can be implemented without departing from a gist or a scope of a comprehensive concept of the invention defined by the attached claims and equivalents thereof.

What is claimed is:

1. A fusion splicing system comprising:
a brightness profile extracting unit configured to extract brightness profile data indicating brightness profile in a radial direction of an optical fiber based on side view image data imaged from the radial direction of the optical fiber;
a classification model creation unit configured to perform machine learning by using teacher data, which are created based on the brightness profile data and indicate a correspondence relationship between the brightness profile in the radial direction of the optical fiber and a type of the optical fiber, and create a classification model that is able to determine the type of the optical fiber for an arbitrary optical fiber based on the brightness profile data indicating the brightness profile in the radial direction of the arbitrary optical fiber;
a determination unit configured to determine the type of the optical fiber of each of a pair of optical fibers using the classification model based on the brightness profile data that is extracted by the brightness profile extracting unit based on the side view image data of the pair of optical fibers as a target of fusion splicing; and
a functional unit configured to fusion-splice the pair of optical fibers based on a fusion condition that is set in accordance with a combination of determined types of the optical fibers.

2. The fusion splicing system according to claim 1, further comprising:
an image processing unit configured to perform augmentation processing on the side view image data of the optical fiber to create a plurality of pieces of the side view image data of the optical fiber, wherein
the brightness profile extracting unit extracts the brightness profile data of the optical fiber from each of the pieces of side view image data obtained through the augmentation processing.

3. The fusion splicing system according to claim 2, wherein the image processing unit performs at least one of rotation, translation, flipping, adjustment of brightness, impartment of noise, and adjustment of focus on image data to perform the augmentation processing on the side view image data of the optical fiber.

4. The fusion splicing system according to claim 3, wherein the adjustment of focus is performed by using an optical simulation of simulating imaging of the side view image data of the optical fiber.

5. The fusion splicing system according to claim 1, wherein the machine learning is performed by using a neural network.

6. The fusion splicing system according to claim 1, wherein the machine learning is processing of learning a correspondence relationship between the brightness profile in the radial direction of the optical fiber and the type of the optical fiber by extracting a characteristic amount of the brightness profile data of the optical fiber and focusing on a characteristic portion having the characteristic amount in the brightness profile data of the optical fiber.

7. The fusion splicing system according to claim 1, wherein,
in a case in which side view image data of a new optical fiber is imaged, the teacher data are updated by adding brightness profile data thereto, the brightness profile data being extracted by the brightness profile extracting unit based on the side view image data of the new optical fiber, and
the classification model creation unit performs the machine learning by using the updated teacher data to update the classification model.

8. A fusion splicer comprising:
a brightness profile extracting unit configured to extract brightness profile data indicating brightness profile in a radial direction of a pair of optical fibers based on side view image data imaged from the radial direction of the pair of optical fibers as a target of fusion splicing;
a determination unit configured to determine a type of the optical fiber for each of the pair of optical fibers by using a classification model based on the brightness profile data of the pair of optical fibers extracted by the brightness profile extracting unit; and
a functional unit configured to fusion-splice the pair of optical fibers based on a fusion condition that is set in accordance with a combination of determined types of the optical fibers, wherein
the classification model is created to perform machine learning by using teacher data indicating a correspondence relationship between the brightness profile in the radial direction of the optical fiber and the type of the optical fiber, and to be able to determine a type of the optical fiber for an arbitrary optical fiber based on brightness profile data indicating brightness profile in a radial direction of the arbitrary optical fiber, and
the teacher data are created to indicate a correspondence relationship between the brightness profile in the radial direction of the optical fiber and the type of the optical fiber based on the brightness profile data extracted from the side view image data of the optical fiber.

9. The fusion splicer according to claim 8, further comprising:
an image processing unit configured to perform augmentation processing on the side view image data of the optical fiber to create a plurality of pieces of the side view image data of the optical fiber, wherein
the brightness profile extracting unit extracts the brightness profile data of the optical fiber from each of the pieces of side view image data obtained through the augmentation processing.

10. The fusion splicer according to claim 9, wherein the image processing unit performs at least one of rotation, translation, flipping, adjustment of brightness, impartment of noise, and adjustment of focus on image data to perform the augmentation processing on the side view image data of the optical fiber.

11. The fusion splicer according to claim 10, wherein the adjustment of focus is performed by using an optical simulation of simulating imaging of the side view image data of the optical fiber.

12. A method of determining a type of an optical fiber, the method comprising:
extracting brightness profile data indicating brightness profile in a radial direction of an optical fiber based on side view image data imaged from the radial direction of the optical fiber;
performing machine learning by using teacher data, which are created based on the brightness profile data and indicate a correspondence relationship between the brightness profile in the radial direction of the optical fiber and a type of the optical fiber and creating a classification model that is able to determine the type of the optical fiber for an arbitrary optical fiber based on brightness profile data indicating brightness profile in the radial direction of the arbitrary optical fiber; and
determining the type of the optical fiber for each of a pair of optical fibers using the classification model based on brightness profile data that is extracted based on side view image data of the pair of optical fibers as a target.

13. The method of determining a type of an optical fiber according to claim 12, the method comprising:
creating a plurality of pieces of side view image data of the optical fiber by performing augmentation processing on the side view image data of the optical fiber; and
extracting the brightness profile data of the optical fiber from each of the pieces of side view image data obtained through the augmentation processing.

14. The method of determining a type of an optical fiber according to claim 13, wherein, in the augmentation processing, the pieces of side view image data of the optical fiber is created by performing at least one of rotation, translation, flipping, adjustment of brightness, impartment of noise, and adjustment of focus on image data.

15. The method of determining a type of an optical fiber according to claim 14, wherein the adjustment of focus is performed by using an optical simulation of simulating imaging of the side view image data of the optical fiber.

16. The method of determining a type of an optical fiber according to claim 12, wherein the machine learning is performed by using a neural network.

17. The method of determining a type of an optical fiber according to claim 12, wherein the machine learning is processing of learning a correspondence relationship between the brightness profile in the radial direction of the optical fiber and the type of the optical fiber by extracting a characteristic amount of the brightness profile data of the optical fiber and focusing on a characteristic portion having the characteristic amount in the brightness profile data of the optical fiber.

18. The method of determining a type of an optical fiber according to claim 12, wherein,
in a case in which side view image data of a new optical fiber is imaged, the teacher data are updated by adding brightness profile data thereto, the brightness profile data being extracted based on the side view image data of the new optical fiber, and
the classification model is updated by performing machine learning using the updated teacher data.
